(19) United States
(12) Patent Application Publication
(10) Pub. No.: US 2008/0223764 A1
(43) Pub. Date: Sep. 18, 2008

(54) Material Separator

(76) Inventor: Dale Dees, McGuireville, AZ (US)

Correspondence Address: BOOTH UDALL, PLC, 1155 W. Rio Salado Pkwy., Suite 101, Tempe, AZ, 85281, US

(21) Appl. No.: 12/128,552

(22) Filed: May 28, 2008

Related U.S. Application Data
(63) Continuation-in-part of application No. 11/421,648, filed on Jun. 1, 2006.
(60) Provisional application No. 60/746,314, filed on May 3, 2006.
(60) Provisional application No. 60/940,628, filed on May 29, 2007.

(51) Int. Cl. B07B 1/28

(52) U.S. Cl. 209/404

(57) ABSTRACT

An apparatus and method for separating material are described. A material separator may comprise a frame. The frame may comprise a base supporting a slanted grate deck. The base may comprise a front wall and two opposing side walls and a suspended deck support positioned below and separated a predetermined distance from the slanted grate deck by at least one deck brace.

### CROSS REFERENCE TO RELATED APPLICATIONS

This application claims priority to U.S. Provisional Patent Application to Dale Dees entitled “Material Separator,” Ser. No. 60/940,628, filed May 29, 2007, and is a continuation in part to U.S. patent application to Dale Dees entitled “Material Separator,” Ser. No. 11/421,648, filed Jun. 1, 2006, now pending, which claims priority to U.S. Provisional Patent Application to Dale Dees entitled “Material Separator,” Ser. No. 60/746,314, filed May 3, 2006, the disclosures all of which are incorporated entirely herein by reference.

### BACKGROUND

A. Technical Field

This document relates to a material separator.

B. Background Art

The separation of material has been performed by utilizing a number of conventional methods and apparatus. However, many conventional methods and apparatus are inefficient at separating material and are not self cleaning.

Additionally, many conventional methods and apparatus must utilize manpower versus operating equipment to manipulate, place, position, service, maintain, and the like different components of the separating apparatuses during various phases of separation processes. When the equipment operator has to get of the equipment to undertake these actions, the result is lost labor and equipment operating time, inconvenience, increased costs, and decreased separated material production.

Furthermore, conventional methods and apparatus have production and service life problems. Apparatuses clog up with material, which minimizes production. In addition, they are not durable and reliable, being susceptible to vibrations, stress, and fractures.

### SUMMARY

In an aspect, this document features a material separator. The material separator may comprise a frame. The frame may comprise a base supporting a slanted grate deck. The base may comprise a front wall and two opposing side walls and a suspended deck support positioned below and separated a predetermined distance from the slanted grate deck by at least one deck brace.

Implementations may include one or more of the following.

The slanted grate deck may further comprise a plurality of grate members and the predetermined distance between the slanted grate deck and the deck support may be one of equal to or greater than a distance between grate members. The grate members and the deck support may be substantially diamond shape in cross-section. The grate members may be of a different size than the deck support.

The at least one deck brace may comprise a plurality of corresponding deck braces, each deck brace coupled between a bottom portion of a corresponding grate member and the suspended deck support.

The suspended deck support may extend across an entire width of the slanted grate deck.

The suspended deck support may be positioned above and separated a predetermined distance from tops of the opposing side walls of the base by opposing side wall braces coupled between end portions of the suspended deck support and top portions of the opposing side walls.

The space between upper ends of at least two grate members may be less than the space between lower ends of the at least two grate members. The spaces between the upper ends of all of the plurality of grate members may be less than the spaces between the lower ends of all of the plurality of grate members. The spaces between the upper ends of all of the plurality of grate members may be equidistant and less than the spaces between the lower ends of all of the plurality of grate members.

The slanted grate deck may comprise an upper end member, an opposing lower end member, and a plurality of grate members located and coupled between the opposing end members. The opposing lower end member may be a top of the front wall. The opposing lower end member may comprise one of: a plurality of teeth coupled to the lower ends of the grate members; and a plurality of reentrant openings defined between coupling locations of the lower ends of the grate members. The opposing lower end member may form a portion of a top of the front wall positioning the slanted grate deck above and separating it a predetermined distance from the top of the front wall.

The foregoing and other aspects and implementations may have one or more or all of the following advantages.

Implementations may comprise FREE RELEASE™ Technology, providing the first ever “non-blinding” and “survivable” decks. Implementations perform along entire length of the decks.

In addition, implementations may comprise FUNNEL EFFECT™ Technology to maximize production and reduce shedding of material off of the decks. The decks create multiple funnels to efficiently collect and separate material, while also providing a strong interface (in both vertical and horizontal directions) to break up and separate material.

Furthermore, implementations may comprise DEAD BLOW™ Technology, making them the first “vibration-dampening” material separators in the industry. With such technology, implementations may not only reduce vibrations, stress, and fractures for increased survivability of the material separator, but they may also add weight and strength to the decks and frames.

Moreover, implementations may comprise BUMP & GO™ Technology, making them the first “self-cleaning” material separators. Reducer screen plug-ups easily removed without operator getting off equipment. An operator need only simply tap reducer screen bumpers with a bucket to shake loose and crush any clogging materials. The bucket then catches any released clogging material for reprocessing or discarding. Thus, implementations keep equipment operators on their equipment (a single operator never has to get out of his seat) during all phases of separation processes, including unclogging or cleaning the material separators, resulting in no lost labor and equipment operating time, convenience, decreased costs, and increased separated material production.

Additionally, implementations may comprise additional technology that allow them to utilize operating equipment versus manpower to place, position, and change out reducer screen decks and to pivot reducer screen decks among other things. For example, suspended deck support bar facilitates transport and movement of material separators. Reducer screen lock facilitates safe transport and pivoting movement of reducer grate decks on material separators. Rigging/tie-down points on frames and reducer grate decks facilitate transport and movement as well. External pickup members facilitate easy placement/removal of reducer grate decks.

Thus, in summary, innovative design ideas come together in material separator implementations to solve existing grizzly production and service life problems. Material separator implementations are:

“non-blinding” for maximum production, performing along entire length of a deck and working every time;

“survivable” (durable and reliable), eliminating vibrations, stress, and fractures and adding weight and strength to decks and frames;

self cleaning so an operator need never get off equipment and hand-clean decks; and

cost effective, keeping equipment operators on equipment during all separation phases, resulting in no lost labor and equipment operating time.

The foregoing and other aspects, implementations, features, and advantages will be apparent from the DESCRIPTION and DRAWINGS, and from the CLAIMS.

### DRAWINGS

Implementations will hereinafter be described in conjunction with the appended DRAWINGS (which are not necessarily to scale), where like designations denote like elements.

FIG. 1 is a back perspective view of a material separator implementation.

FIG. 2 is a front perspective view of the material separator implementation of FIG. 1.

FIG. 3 is side view of the material separator implementation of FIG. 1.

FIG. 4 is a front perspective view of a frame of the material separator implementation of FIG. 1.

FIG. 5 is a front perspective view of a portable, interchangeable reducer grate deck of the material separator implementation of FIG. 1.

FIG. 6 is a broken away back perspective view of the material separator implementation of FIG. 1 depicting the marriage of the frame and the portable, interchangeable reducer grate deck.

FIG. 7 is a cross section view taken along line 7-7 of FIG. 6.

FIG. 8 is a cross section view similar to FIG. 7 of another material separator implementation.

FIGS. 9-16 are various side and perspective views of the material separator implementation of FIG. 1 during use.

FIG. 17 is a front perspective view of another material separator implementation.

FIG. 18 is a front view of the material separator implementation of FIG. 17.

FIG. 19 is a back view of the material separator implementation of FIG. 17.

FIG. 20 is a broken away front perspective view of still another material separator implementation.

FIG. 21 is a front perspective view of yet another material separator implementation depicting the marriage of a frame and a portable, interchangeable reducer grate deck.

FIG. 22 is a broken away front view of the material separator implementation of FIG. 21.

FIG. 23 is a back perspective view of the material separator implementation of FIG. 21.

FIGS. 24-26 are various perspective views of the material separator implementation of FIG. 17 during use.

FIGS. 27-28 are front perspective and front views respectively of another material separator implementation.

### DESCRIPTION

A. Structure

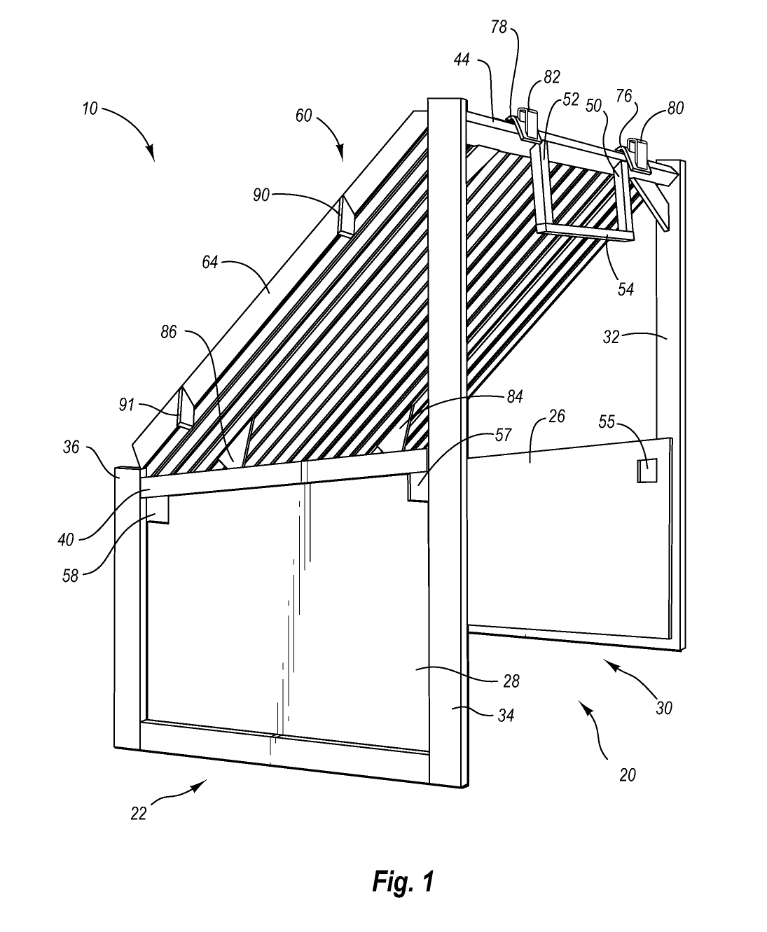

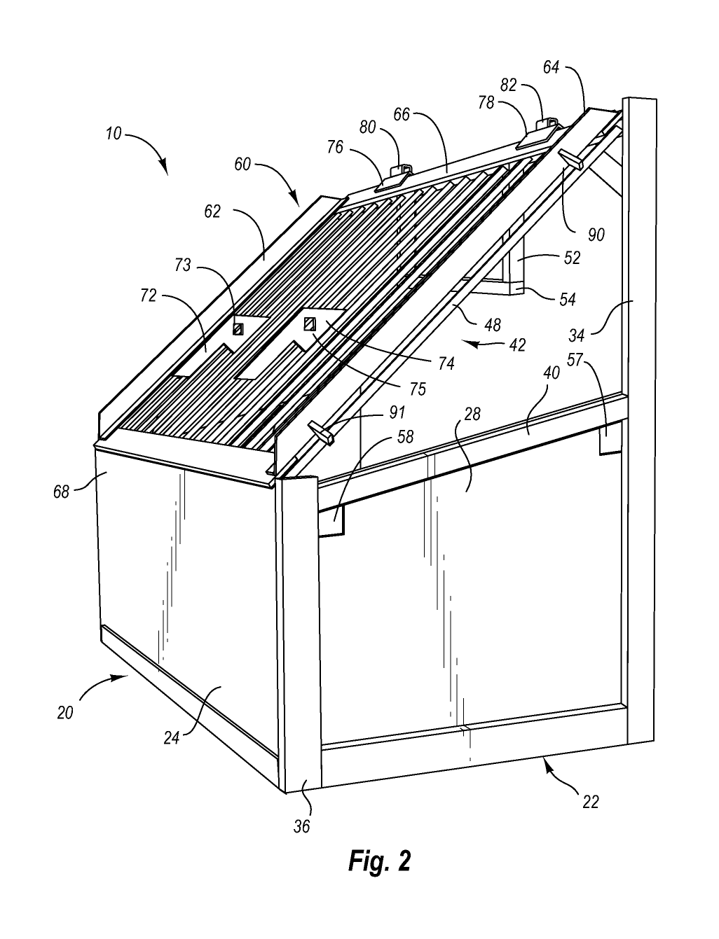

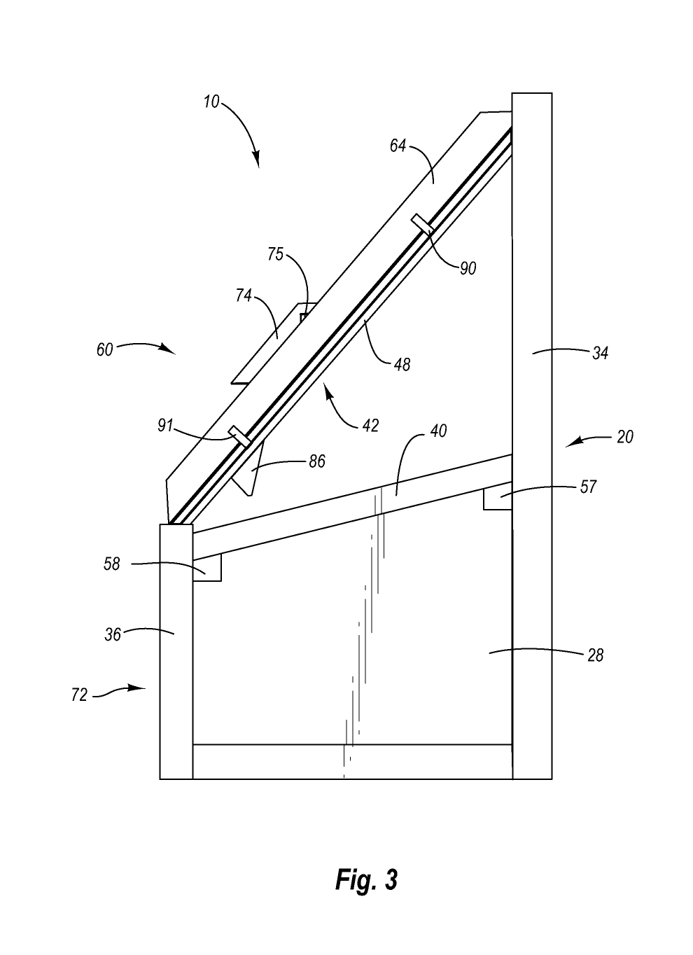

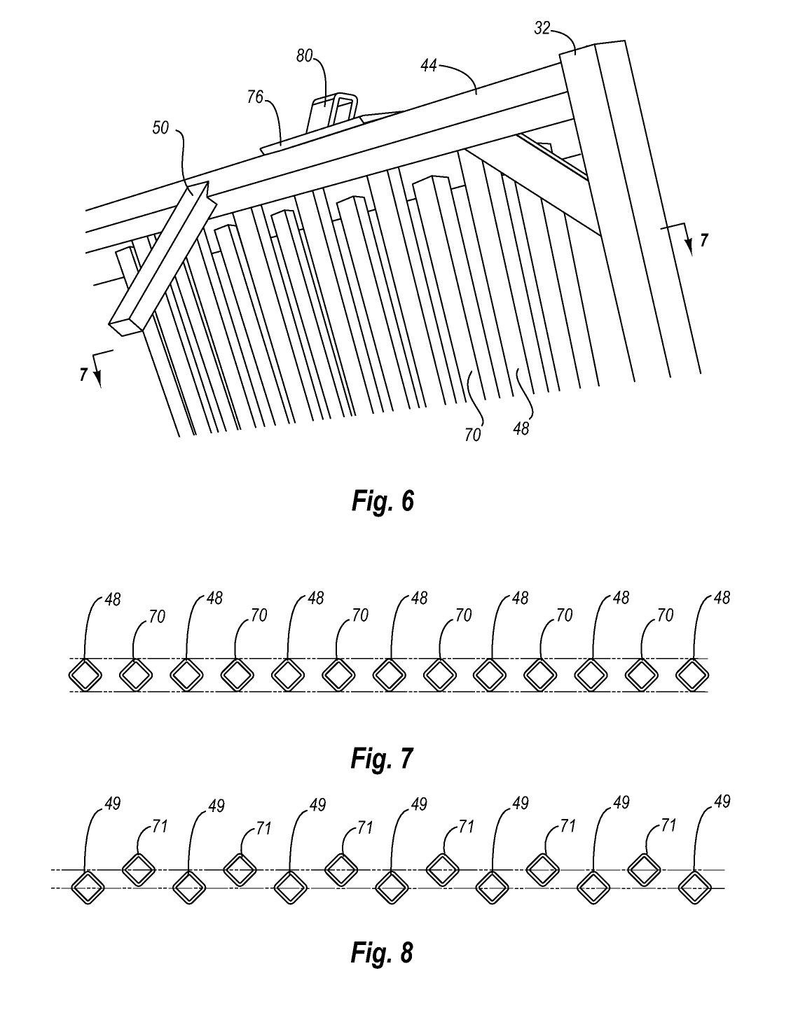

There are a variety of material separator implementations. Notwithstanding, with reference to FIGS. 1-7 and for the exemplary purposes of this disclosure, a material separator implementation is depicted. Material separator 10 includes: a frame 20 comprising a base 22 supporting a slanted grate deck 42; and at least one portable, interchangeable reducer grate deck 60 that is configured to removably couple with slanted grate deck 42.

More specifically, frame 20 comprises box-like base 22 that includes: front wall 24, two opposite side walls 26 and 28, open back 30, a pair of slanted side support members 38 and 40, a pair of spaced apart upright front supports 35 and 36, and a pair of spaced apart upright back supports 32 and 34. The lower portions of the pair of upright back supports 32 and 43 are coupled opposite one another to the back ends of the opposite side walls 26 and 28, respectively. Slanted side support members 38 and 40 extend between upright front support 35 and upright back support 32 and upright front support 36 and upright back support 34, respectively. Slanted side support members 38 and 40 are adjacent the upper portions of sidewalls 26 and 28, respectively, with the tops of slanted side support members 38 and 40 flush with or below the tops of sidewalls 26 and 28, respectively. Slanted side support members 38 and 40 prevents material (material that can fall of when the material separator is being transported later) from building up on their top surfaces—more easily shed material off.

Frame 20 also comprises slanted grate deck 42 coupled between the pair of spaced apart upright front supports 35 and 36 and the pair of spaced apart upright back supports 32 and 34. Slanted grate deck 42 has two opposite end members 44 and 46 and a plurality of grate members 48 located between opposite end members 44 and 46. Upper and lower end members 44 and 46 respectively of slanted grate deck 42 may be coupled to and separate the upper portions of upright back supports 32 and 34 and the upper portions of upright front supports 35 and 36 along the upper portion of front wall 24. Grate members 48 may have a diamond shape in cross-section (see FIG. 7). Such a configuration gives strength in both the vertical and horizontal directions and eliminates the need for any extra supports for slanted screen deck 42. Such a configuration also provides a more efficient and strong interface (e.g., sharper edges of grate members 48 as opposed to flat sides) to break up and separate material. Additionally, such a configuration creates multiple funnels/channels between grate members 48 to more efficiently collect and separate material; more of the material that is placed on slanted grate deck 42 is separated, while less is shed off the surface. In the end, this helps the operator to be more efficient and to maximize the separation of material.

Frame 20 may also include at least one lift member. For example, lift members 50 and 52 are shown extending downwardly from the upper end portion of slanted grate deck 42 in order to enable transport and movement of frame 20 or material separator 10 with a front end bucket of a backhoe, a front end loader, or the like for example as described below. Lift members 50 and 52 may be located spaced apart along upper end member 44 between upright supports 32 and 34. Lift members 50 and 52 may alternatively be located on the upper portions of two separate grate members 48. In addition, cross member 54 may be included that is removably coupled to the ends of lift members 50 and 52 by any appropriate fastening mechanisms to further facilitate the transport and movement of frame 20 or material separator 10 with a bucket of an excavator or the like.

Frame 20 may also include at least one rigging member to further facilitate the transport and movement of frame 20 or material separator 10 by an excavator or the like or to provide tie-down points for frame 20 when it is being transported on a truck for example from job site to job site. The rigging members accommodate and/or removably couple with any appropriate cables, swings, chokers, chains, and/or the like that may be used in conjunction with an excavator, truck, or the like. For example, a pair of spaced apart rigging members 55 and 56 and a pair of spaced apart rigging members 57 and 58 are shown, and they may be located on sidewalls 26 and 28, respectively, in the comers that are formed between upright back and front supports 32 and 35 and slanted side support member 38 and upright back and front supports 34 and 36 and slanted side support member 40 respectively. In this implementation, for example, rigging members 55, 56, 57, and 58 are holes through sidewalls 26 and 28.

Portable, interchangeable reducer grate deck 60 includes two opposite side members 62 and 64, two opposite end members 66 and 68, and a plurality of grate members 70 located between opposite end members 66 and 68. Grate members 70 may have a diamond shape in cross-section (see FIG. 7). Such a configuration gives strength in both the vertical and horizontal directions and eliminates the need for any extra supports for reducer grate deck 60. Such a configuration also provides a more efficient and strong interface (e.g., sharper edges of grate members 70 as opposed to flat sides) to more easily break up and separate material. Additionally, such a configuration creates multiple funnels/channels between grate members 70 and grate members 48 to more efficiently collect and separate material; more of the material that is placed on the reducer grate deck 60/slanted grate deck 42 combination is separated, while less is shed off the surface. In the end, this helps the operator to be more efficient and to maximize the separation of material.

Grate members 70 may be substantially parallel with the opposite side members 62 and 64, but could be placed in other orientations depending upon the orientation of grate bars 42 of slanted grate deck 42 for example. Regardless, when reducer grate deck 60 is installed on slanted grate deck 42, grate members 70 mesh or nest between grate members 48 to form a unitary, flush decking as can be seen from the cross section in FIG. 7.

Reducer grate deck 60 may also include at least one external pick up member. For example, two external pick up members 72 and 74 are shown that attach to the tops or sides of two different grate members 70 so that a front end bucket of a backhoe may engage them and lift and move reducer grate deck 60 as described below.

Reducer grate deck 60 may also include at least one catch member capable of removably and pivotally engaging upper end member 44 of slanted grate deck 42 allowing pivoting of reducer grate deck 60 when unclogged material needs to be released. For example, two spaced apart catch members 76 and 78 are shown coupled to and extending from upper end member 66 of reducer grate deck 60. Catch members 76 and 78 may each be an angle member, one side coupled to upper end member 66 and the other side fitting around the outer perimeter of upper end member 44 of slanted grate deck 42 when reducer grate deck 60 is properly positioned in frame 20.

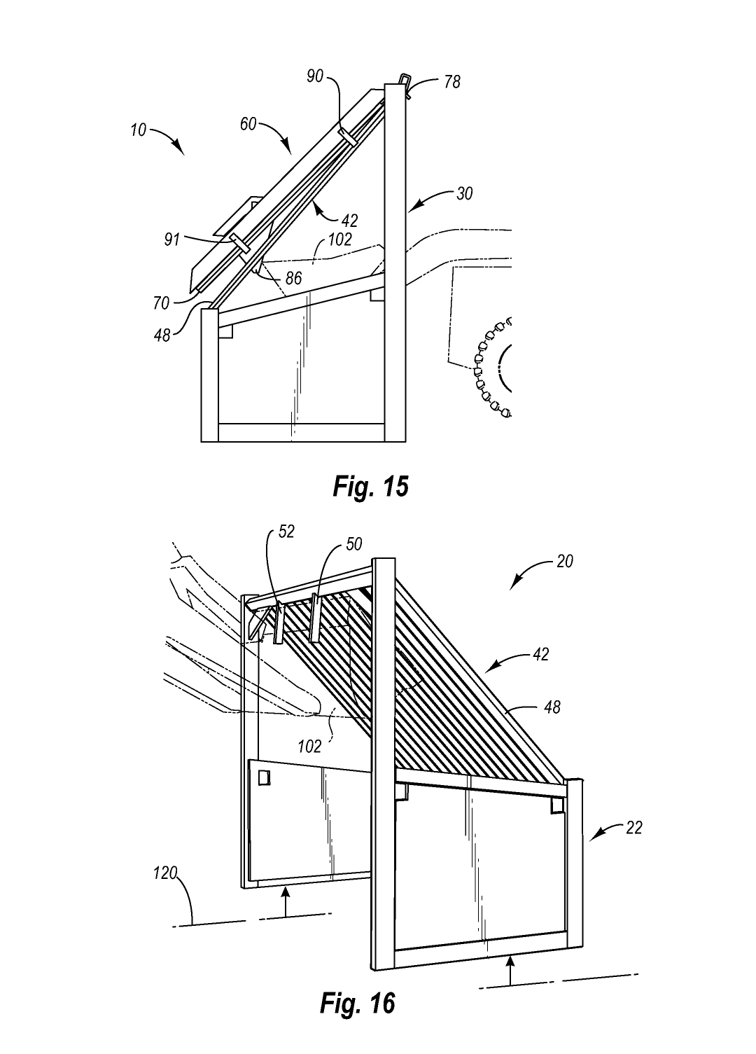

Reducer grate deck 60 may also include at least one internal bumper configured to engage a front end bucket of a backhoe for example to help clear any clogged material on/in reducer grate deck 60. For example, two internal bumpers 84 and 86 are shown attached to the bottoms or sides of two different grate members 70. The grate members 70 may be the same grate members to which pick up members 72 and 74 are attached, or they may be different grate members, such as adjacent grate bar members. Bumpers 84 and 86 may be triangular or rectangular in shape for example. Triangular shaped bumpers 84 and 86 are actually shown and serve many useful purposes. The front end bucket of a backhoe just needs to be aligned with bumpers 84 and 86 and then the backhoe just needs to drive forward to slidably push the free, non-pivoting end of reducer grate deck 60 upwards to clear any clogged materials as described below and depicted in FIG. 15. Continuing to drive the backhoe forward allows bumpers 84 and 86 to slip inside of the bucket and reducer grate deck 60 to fall forcefully back into position, further shaking loose or crushing any lingering clogging materials. Additionally, the bucket is in a position to catch any released clogging material that may fall through the decking so it can be reprocessed if desired or discarded, thereby preventing released clogging material from mixing with the previously separated finer material.

Reducer grate deck 60 may also include at least one seating tab on each of opposite side members 62 and 64 that help align and seat reducer grate deck 60 on slanted grate deck 42 during installation of the same or when using a front end bucket of a backhoe for example to engage bumpers 84 and 86 and push the free, non-pivoting end of reducer grate deck 60 upwards to clear any clogged materials (i.e. keep reducer grate deck 60 centered with slanted grate deck 42 so as to not change the spacing between grate members 48 and 70 and ultimately the size of screened material). For example, two pairs of seating tabs are shown, namely, spaced apart seating tabs 88 and 89 coupled on side member 62 and spaced apart seating tabs 90 and 91 coupled on side member 64. Seating tabs 88, 89, 90, and 91 all extend outwardly at a downward angle from side members 62 and 64, respectively.

Reducer grate deck 60 may also include at least one rigging member to further facilitate the transport and movement of reducer grate deck 60 by an excavator or the like or to provide tie-down points for reducer grate deck 60 when it is being transported on a truck for example from job site to job site. The rigging members accommodate and/or removably couple with any appropriate cables, swings, chokers, chains, and/or the like that may be used in conjunction with an excavator, truck, or the like. For example, as depicted, rigging members 80 and 82 may be located on catch members 76 and 78 respectively (or spaced apart along upper end member 66 for example) and rigging members 73 and 75 may be located on external pick up members 72 and 74 respectively (or spaced apart along lower end member 68 for example). In this implementation, for example, rigging members 73 and 75 are holes through pick up members 72 and 74, respectively, while rigging members 80 and 82 are upside down U- or J-shaped channel sections coupled to catch members 76 and 78, respectively.
B. Other Implementations

Many additional implementations are possible in addition to those previously discussed.

For the exemplary purposes of this disclosure, other material separator implementations may comprise a substantially unitary, flush decking arrangement, as opposed to the unitary, flush decking arrangement depicted in FIG. 7. In particular and referring to FIG. 8, grate members 71 partially (e.g., about half of the member) mesh or nest between grate members 49 to form a substantially unitary, flush decking. Alternatively, grate members of a reducer grate deck may not mesh or nest (e.g., no overlap at all) between grate members of a slanted grate deck, but are instead in a raised position above the grate members of a slanted grate deck.

For the exemplary purposes of this disclosure, still other material separator implementations may comprise grate members of a reducer grate deck of a different size (e.g., larger or smaller) than grate members of a slanted grate deck. For example, if there is a wide spacing between grate members of a slanted grate deck, two or more reducer grate decks may be provided with grate members of a different size (e.g., larger or smaller) than the grate members of the slanted grate deck so as to provide for screened material across a range of various sizes.

For the exemplary purposes of this disclosure, yet other material separator implementations may comprise a double sided or plated front wall. The double sided front wall may comprise a U-shaped or H-shaped base member, an inside wall plate and an outside wall plate coupled to the inside surfaces of the side walls of the U-shaped or H-shaped base member, and at least one (e.g., two) internal upright support members separating the inside wall plate and the outside wall plate. Such a double sided front wall not only prevents material from building up on exposed surfaces (material that can fall of when the material separator is being transported) but it provides protection from wall damage due to a bucket of a backhoe maneuvering inside the base of the frame.

For the exemplary purposes of this disclosure, even other material separator implementations may comprise one longer, angled catch member, a plurality of shorter angled catch members, and the like. Additionally, the upper end member itself of the reducer grate deck could function as a catch member or catch members. That is, for example, the upper end member itself may be an angle catch member or may have one or more integral flanges.

For the exemplary purposes of this disclosure, still other material separator implementations may comprise rigging members other than holes or channel sections for example, such as rings, eyelets, hooks, clips, and/or any other suitable rigging mechanisms. Additionally, a plurality of rigging members may be included positioned at different locations on the sidewalls of the base for example.

For the exemplary purposes of this disclosure, yet other material separator implementations may comprise portable, interchangeable slanted screen decks. These portable, interchangeable slanted screen decks may be positioned and removably coupled in any suitable manner. For example, some portable, interchangeable slanted screen decks may be configured similar to the reducer grate decks previously described to include at least one catch member that couples to a horizontal bar between the upper end portions of the upright support members. Alternatively, other portable, interchangeable slanted screen decks may each be configured with a lip extending around the perimeter of the slanted screen deck. The lip may fit around each of the upper ends of the upright front and back supports for example when the interchangeable slanted screen deck is installed. Various locking mechanisms for holding the portable, interchangeable slanted screen decks in place may also be provided.

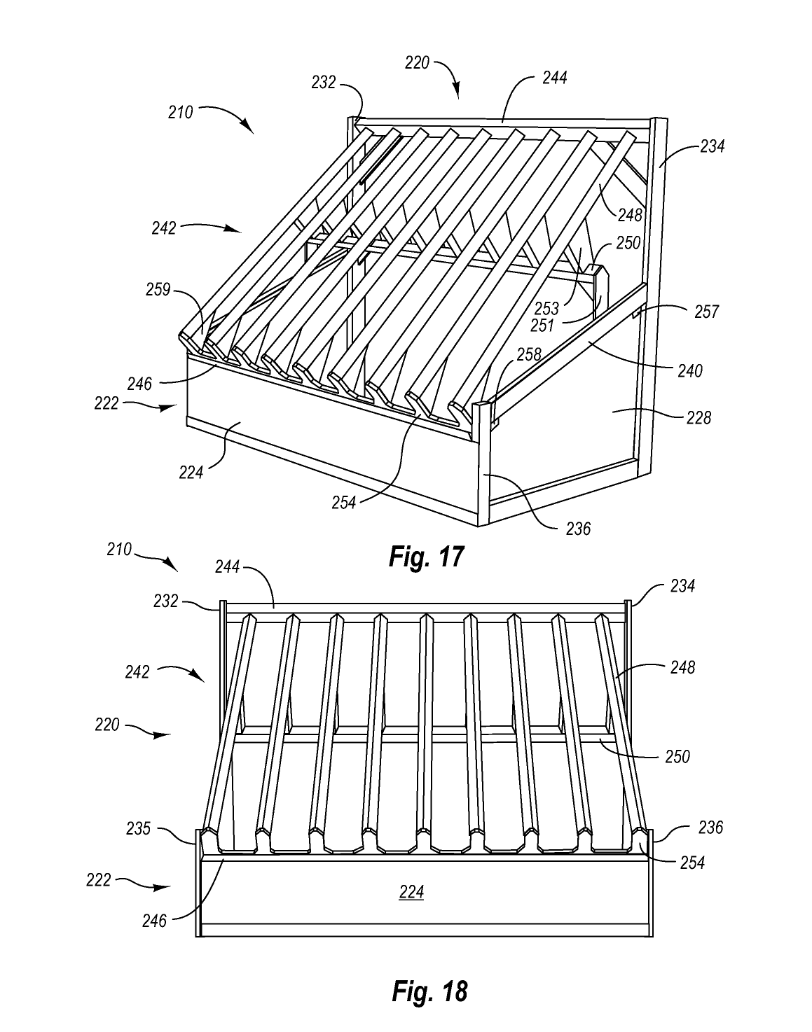

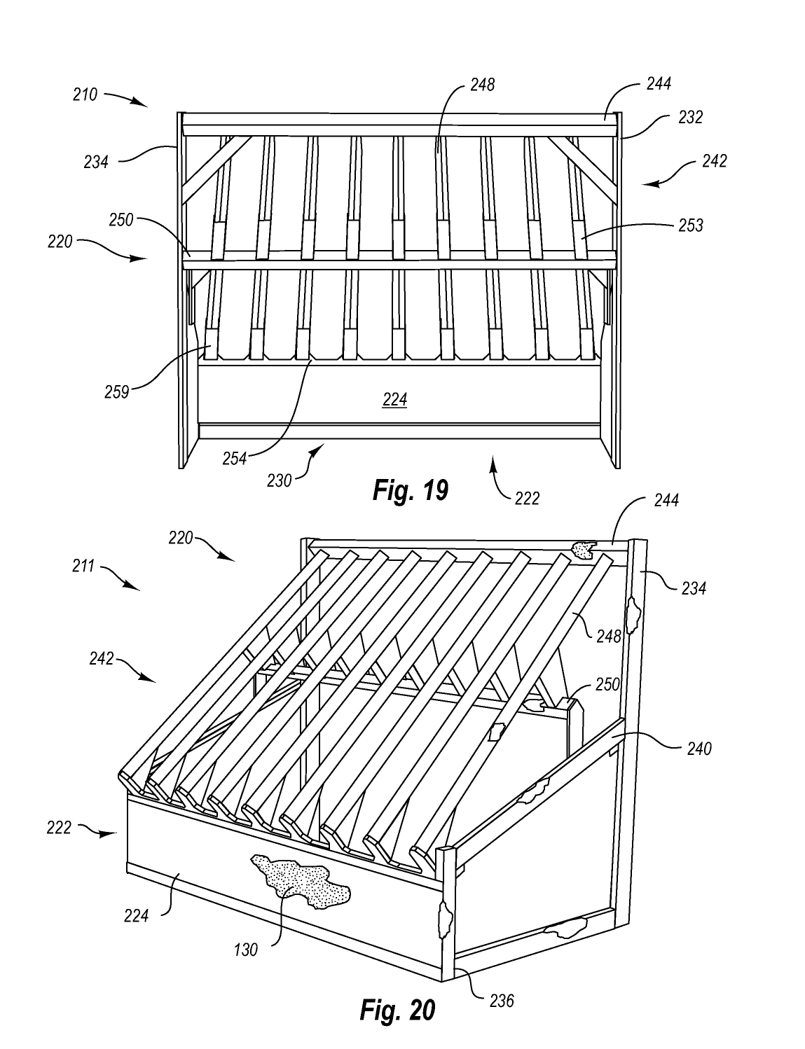

For the exemplary purposes of this disclosure and with reference to FIGS. 17-19, another material separator implementation is depicted. Generally, material separator 210 includes a frame 220 comprising a base 222 supporting a slanted grate deck 242.

More specifically, frame 220 comprises box-like base 222 that includes: front wall 224, two opposite side walls 226 and 228, open back 230, a pair of slanted side support members 238 and 240, a pair of spaced apart upright front supports 235 and 236, and a pair of spaced apart upright back supports 232 and 234. The lower portions of the pair of upright back supports 232 and 243 are coupled opposite one another to the back ends of the opposite side walls 226 and 228, respectively. Slanted side support members 238 and 240 extend between upright front support 235 and upright back support 232 and upright front support 236 and upright back support 234, respectively, at any angle above zero degrees, such as about ten degrees to about thirty degrees for example or about twenty degrees to about twenty-five degrees for example. Slanted side support members 238 and 240 are adjacent the upper portions of sidewalls 226 and 228, respectively, with the tops of slanted side support members 238 and 240 flush with or below the tops of sidewalls 226 and 228, respectively. Slanted side support members 238 and 240 prevents material (material that can fall of when the material separator is being transported later) from building up on their top surfaces—more easily shed material off.

Frame 220 may also include at least one rigging member to further facilitate the transport and movement of frame 220 or material separator 210 by an excavator or the like or to provide tie-down points for frame 220 when it is being transported on a truck for example from job site to job site. The rigging members accommodate and/or removably couple with any appropriate cables, swings, chokers, chains, and/or the like that may be used in conjunction with an excavator, truck, or the like. For example, a pair of spaced apart rigging members 255 and 256 and a pair of spaced apart rigging members 257 and 258 are shown, and they may be located on sidewalls 226 and 228, respectively, in the corners that are formed between upright back and front supports 232 and 235 and slanted side support member 238 and upright back and front supports 234 and 236 and slanted side support member 240 respectively. In this implementation, for example, rigging members 255, 256, 257, and 258 are holes through sidewalls 226 and 228.

Frame 220 also comprises slanted grate deck 242 coupled between the pair of spaced apart upright front supports 235 and 236 and the pair of spaced apart upright back supports 232 and 234. Slanted grate deck 242 has two opposite end members 244 and 246 and a plurality of grate members 248 located between opposite end members 244 and 246 directly or indirectly. Upper and lower end members 244 and 246 respectively of slanted grate deck 242 may be coupled to and separate the upper portions of upright back supports 232 and 234 and the upper portions of upright front supports 235 and 236 along or as part of the upper portion of front wall 224. Grate members 248 may have a diamond shape in cross-section (see FIG. 7). Such a configuration gives strength in both the vertical and horizontal directions. Such a configuration also provides a more efficient and strong interface (e.g., sharper edges of grate members 48 as opposed to flat sides) to break up and separate material. Additionally, such a configuration creates multiple funnels/channels between grate members 248 to more efficiently collect and separate material; more of the material that is placed on slanted grate deck 242 is separated, while less is shed off the surface. In the end, this helps the operator to be more efficient and to maximize the separation of material.

More specifically, in slanted grate deck 242, the spaces between upper ends of grate members 248 may be less than the spaces between lower ends grate members 248. For example, the spaces between the upper ends of grate members 248 may be equidistant and less than the spaces between the lower ends of grate members 248. Alternatively, the spaces between the upper ends of grate members 248 may be less than the spaces between the lower ends of grate members 248 and the spaces between the lower ends of grate members 248 may be equidistant. Optionally, the spaces between the upper ends of grate members 248 may be equidistant and less than the spaces between the lower ends of grate members 248, and the spaces between the lower ends of grate members 248 may be equidistant.

Slanted grate deck 242 may extend down to a position above the top of front wall 224, slanted grate deck 242 separated a predetermined distance from the top of front wall 224 providing an “open front” so that larger material may shed more freely and not clog up the end of slanted grate deck 242. The predetermined distance between slanted grate deck 242 and the top of front wall 224 may be one of equal to or greater than a distance between grate members 248.

Opposing lower end member 246 of slanted grate deck 242 may form a portion of the top of front wall 224 indirectly positioning slanted grate deck 242 above and separating it a predetermined distance from the top of front wall 224. Specifically and as depicted in the figures, slanted grate deck 242 may be positioned above and separated a predetermined distance from the top of front wall 242 by at least one front wall brace 254 coupled between slanted grate deck 242 and the top of front wall 224. At least one front wall brace 254 may comprise an elongated brace as depicted comprising a plurality of corresponding front wall brace portions, and the elongated brace may be coupled to the top of front wall 224 and each front wall brace portion thereof may be coupled between an end portion of a corresponding grate member 248. Channels may be defined between the front wall brace portions. Alternatively, the front wall brace 254 may comprise a plurality of corresponding front wall braces, and each front wall brace may be coupled between an end portion of a corresponding grate member 248 and the top of front wall 224 independently, with channels being defined between the individual front wall braces.

Alternatively, opposing lower end member 246 may be the top of front wall 224. Opposing lower end member 246 may comprise one of: a plurality of teeth coupled to the lower ends of grate members 248; and a plurality of reentrant openings defined between coupling locations of the lower ends of grate members 248. The spaces between the plurality of teeth or the plurality of reentrant openings may comprise heights that are one of equal to or greater than a distance between grate members 248.

Base 222 may further comprise suspended deck support 250 positioned below and separated a predetermined distance from slanted grate deck 242 by deck braces 253 corresponding to grate members 248, each deck brace 253 coupled between a bottom portion of a corresponding grate member 248 and suspended deck support 250. The predetermined distance between slanted grate deck 242 and deck support 250 may be one of equal to or greater than a distance between grate members 248.

Deck support 250 may be substantially diamond shape in cross-section (so that material more easily sheds off of its surface for example) and may be of a different size than grate members 248. Suspended deck support 250 may extend across an entire width of slanted grate deck 250. Suspended deck support 250 may be positioned above and separated a predetermined distance from tops of opposing sidewalls 226 and 228 of base 222 by opposing side wall braces 251 and 252 coupled between end portions of suspended deck support 250 and top portions of opposing sidewalls 226 and 228.

With reference to FIG. 20 and for the exemplary purposes of this disclosure, yet another material separator implementation is depicted. Material separator 211 is similar to material separator 210 previously described. The principal difference is the inclusion of a dead-blow/vibration dampening material in any portion(s) of frame 220, or for that matter in any portion(s) of a reducer grate deck. The vibration dampening materials not only add weight and strength to material separator 211, but they alleviate resonant frequencies and vibrations in the components of material separator 211 when material separator 211 is in use reducing stress and fractures to the components.

Consequently, sand or wet sand 130 for example may be used to fill all or portions of base 222. For example, front wall 224 and back supports 232 and 234 may be filled with sand 130. Sand or wet sand 130 may also be used to fill all or portions of slanted grate deck 242. For example, grate members 248 and upper and lower end members 244 and 246 may be filled with sand 130. Sand or wet sand 130 may also be used to fill suspended deck support 250. Sand or wet sand 130 may also be used to fill all or portions of a reducer grate deck (not shown in FIG. 20). For example, the grate members and the upper and lower end members of the reducer grate deck may be filled with sand 130.

As depicted, vibration dampening material 130 may be sand 130. Notwithstanding, the vibration dampening material may be any other suitable material, such as shock-absorbing gel (e.g., silicone rubber, PVC plastisol, synthetic rubber, thermoplastic rubber, natural rubber, and the like), foam, polyurethane, and the like.

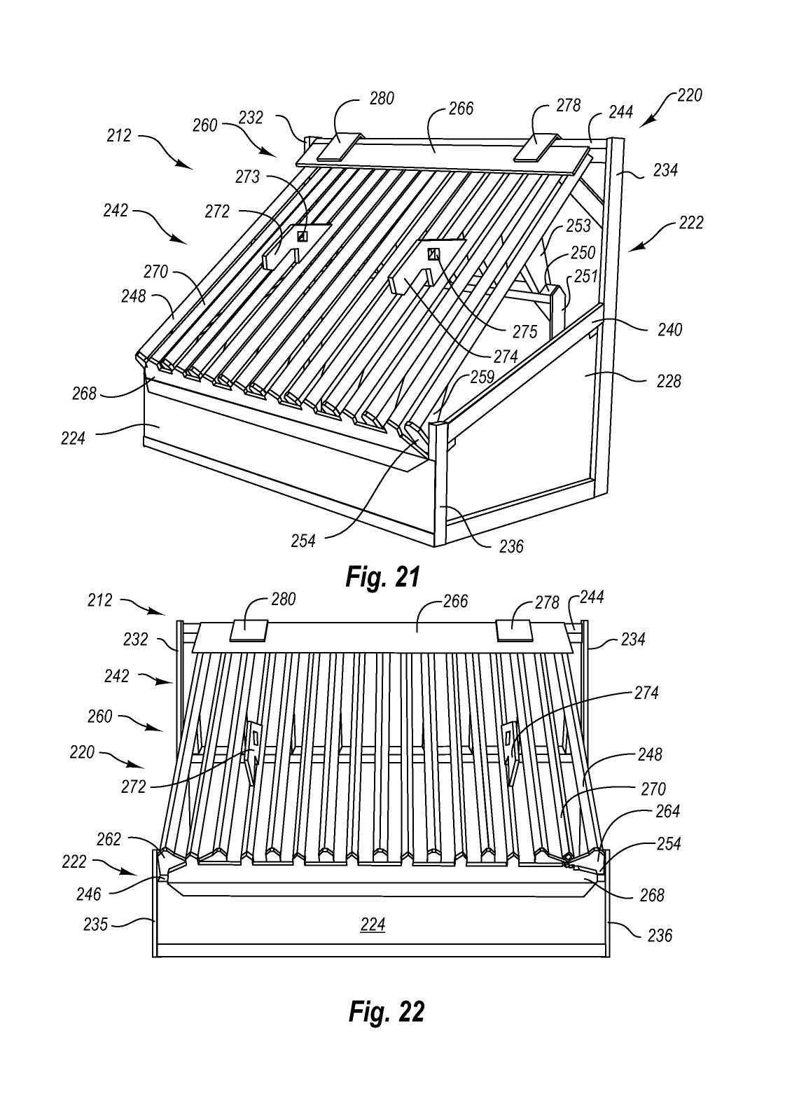

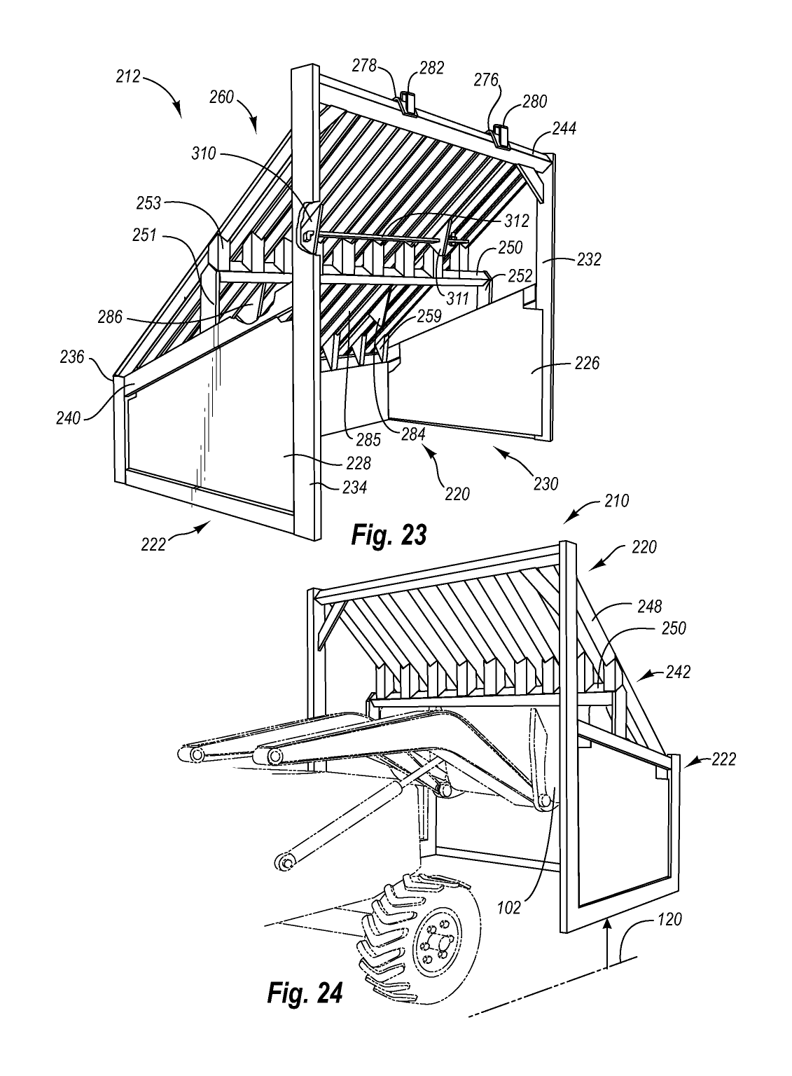

With reference to FIGS. 21-23 and for the exemplary purposes of this disclosure, even another material separator implementation is depicted. Material separator 212 is similar to material separator 210 previously described. The principal difference is the inclusion of portable, interchangeable reducer grate deck 260 that is configured to removably couple with slanted grate deck 242.

Base 222 may comprise two opposing seating members 262 and 264, each seating member coupled to and extending upwardly from an opposing top end portion of front wall 224. Seating members 262 and 264 may each comprise a receiving notch corresponding to the shape of a grate member 270 of reducer grate deck 260. Opposing external grate members 270 may each correspond with and seat on corresponding opposing seating members 262 and 264 respectively. Opposing seating members 262 and 264 may position reducer grate deck 260 above and separate it a predetermined distance from a top of front wall 224. The predetermined distance between a bottom surface of reducer grate deck 260 and the top of front wall 224 may be one of equal to or greater than a distance between grate members 270 of reducer grate deck 260. Opposing seating members 262 and 264 help align and seat reducer grate deck 260 on slanted grate deck 242 during installation of the same or when using a front end bucket of a backhoe for example to engage bumpers 284 and 286 and push the free, non-pivoting end of reducer grate deck 260 upwards to clear any clogged materials (i.e. keep reducer grate deck 260 centered with slanted grate deck 242 so as to not change the spacing between grate members 248 and 270 and ultimately the size of screened material).

Portable, interchangeable reducer grate deck 260 comprises two opposite end members 266 and 268 and a plurality of grate members 270 located between opposite end members 266 and 268. Grate members 270 may have a diamond shape in cross-section. Such a configuration gives strength in both the vertical and horizontal directions and eliminates the need for any extra supports for reducer grate deck 260. Such a configuration also provides a more efficient and strong interface (e.g., sharper edges of grate members 270 as opposed to flat sides) to more easily break up and separate material. Additionally, such a configuration creates multiple funnels/channels between grate members 270 and grate members 248 to more efficiently collect and separate material; more of the material that is placed on reducer grate deck 260/slanted grate deck 242 combination is separated, while less is shed off the surface. In the end, this helps the operator to be more efficient and to maximize the separation of material.

Grate members 270 may be spaced in a compatible orientation with respect to the orientation of grate bars 248 of slanted grate deck 242 for example. Thus, when reducer grate deck 260 is installed on slanted grate deck 242, grate members 270 may mesh or nest between grate members 248 to form a unitary (or substantially unitary), flush decking for example. More specifically, in reducer grate deck 260, the spaces between upper ends of grate members 270 may be less than the spaces between lower ends grate members 270. For example, the spaces between the upper ends of grate members 270 may be equidistant and less than the spaces between the lower ends of grate members 270. Alternatively, the spaces between the upper ends of grate members 270 may be less than the spaces between the lower ends of grate members 270 and the spaces between the lower ends of grate members 270 may be equidistant. Optionally, the spaces between the upper ends of grate members 270 may be equidistant and less than the spaces between the lower ends of grate members 270, and the spaces between the lower ends of grate members 270 may be equidistant.

Reducer grate deck 260 may also include at least one external pick up member. For example, two external pick up members 272 and 274 are shown that attach to the tops or sides of two different grate members 270 so that a front end bucket of a backhoe may engage them and lift and move reducer grate deck 260.

Reducer grate deck 260 may also include at least one catch member capable of removably and pivotally engaging upper end member 244 of slanted grate deck 242 allowing pivoting of reducer grate deck 260 when unclogged material needs to be released. For example, two spaced apart catch members 278 and 280 are shown coupled to and extending from upper end member 266 of reducer grate deck 260. Catch members 278 and 280 may each be an angle member, one side coupled to upper end member 266 and the other side fitting around the outer perimeter of upper end member 244 of slanted grate deck 242 when reducer grate deck 260 is properly positioned in frame 220.

Reducer grate deck 260 may also comprise at least one internal bumper configured to engage a front end bucket of a backhoe for example to help clear any clogged material on/in reducer grate deck 260. For example, two internal bumpers 284 and 286 are shown attached to the bottoms or sides of two different grate members 270. The grate members 270 may be the same grate members to which pick up members 272 and 274 are attached, or they may be different grate members, such as adjacent grate bar members. Bumpers 284 and 286 may be triangular or rectangular in shape for example. Triangular shaped bumpers 284 and 286 are actually shown and serve many useful purposes. The front end bucket of a backhoe just needs to be aligned with bumpers 284 and 286 and then the backhoe just needs to drive forward to slidably push the free, non-pivoting end of reducer grate deck 260 upwards to clear any clogged materials. Continuing to drive the backhoe forward allows bumpers 284 and 286 to slip inside of the bucket and reducer grate deck 260 to fall forcefully back into position, further shaking loose or crushing any lingering clogging materials. Additionally, the bucket is in a position to catch any released clogging material that may fall through the decking so it can be reprocessed if desired or discarded, thereby preventing released clogging material from mixing with the previously separated finer material.

Reducer grate deck 260 may also comprise at least one internal locking member capable of keeping reducer grate deck 260 safely secured to material separator 212 while being transported, as well as keeping reducer grate deck 260 safely secured to material separator 212 while material separator 212 is in use. For example, internal locking members 310 and 311 are shown, each comprising holes there through adjacent (near or close to, but not touching) a bottom surface of reducer grate deck 260. The internal locking members 310 and 311 may comprise angled internal locking members 310 and 311. Internal locking members 310 and 311 may be coupled to upper portions of corresponding different grate members 270 of reducer grate deck 260 so that locking members 310 and 311 are located between deck braces 253 and end member 244 of slanted grate deck 242.

A bar 312 may be inserted through the holes in internal locking members 310 and 311 such that bar 312 is adjacent (near or close to, but not touching) the bottom surface of reducer grate deck 260 as well. Bar 313 may be held in place by a bolt, a bolt and nut, a pin, pin and clip, a pin and padlock style lock, combination bar lock-re-settable combination lock, a pin and swivel head lock, a bent pin with pushbutton lock, a keyed bar lock, and the like if desired.

Internal locking members 310 and 311 and bar 313 keep reducer grate deck 260 safely secured to material separator 212 while being transported. Even if catch members 278 and 280 were to somehow disengage during transport or other movement of material separator 212, reducer grate deck 260 would not disengage from grate deck 242. Rather at most, it would slide down slanted grate deck 242 until deck braces 253 stopped bar 313. Notwithstanding, internal locking members 310 and 311 and bar 313 also keep reducer grate deck 260 safely secured to material separator 212 while material separator 212 is in use as well, thereby preventing any inadvertent dislodgement of reducer grate deck 260 and lost production time in having to reinstall it. Thus, even if bar 313 is installed, bumpers 284 and 286 can still be engaged to clean reducer grate deck 260 as described below because of the predetermined space between bar 313 and the bottom surfaces of grate members 270 of reducer grate deck 260 which still allows reducer grate deck 260 to pivot upwards.

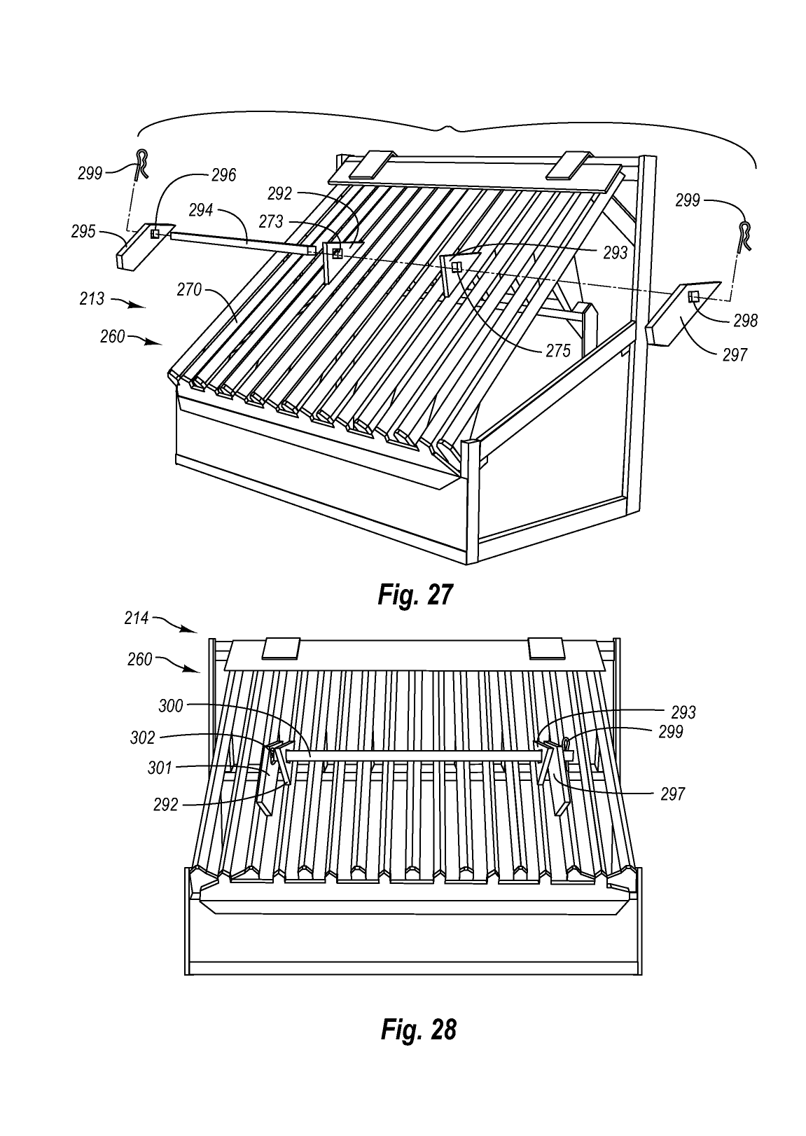

With reference to FIGS. 27-28 and for the exemplary purposes of this disclosure, even other material separator implementations are depicted. Material separators 213 and 214 are similar to material separator 212 previously described. The principal differences are the inclusion of rigging members 292 and 293 and removable pick up assemblies.

Accordingly, material separator 213 comprises rigging members 292 and 293 coupled to the tops or sides of two different grate members 270 of reducer grate deck 260. Rigging members 292 and 293 each comprise holes 273 and 275 respectively there through. Rigging members 292 and 293 facilitate the transport, movement, lifting, placement, or the like of reducer grate deck 260 by an excavator or the like, or to provide tie-down points when material separator 213 and reducer grate deck 260 are being transported on a truck for example from job site to job site. Rigging members 292 and 293 accommodate and/or removably couple with any appropriate cables, swings, chokers, chains, and/or the like that may be used in conjunction with an excavator, truck, or the like.

Material separator 213 also includes a pick up assembly that comprises a pair of removable pick up members 295 and 297 (each comprising holes 296 and 298 respectively there through) that can be removably coupled to opposite ends of a removable bar 294 that can be removably coupled/slid through holes 273 and 275 so that a front end bucket of a backhoe may engage removable pick up members 295 and 297 and lift and move reducer grate deck 260. Removable pick up members 295 and 297 and removable bar 294 may be held in place with respect to each other and rigging members 292 and 293 by pins 299 or any other device, such as a bolt, a bolt and nut, a pin, pin and clip, a pin and padlock style lock, combination bar lock-re-settable combination lock, a pin and swivel head lock, a bent pin with pushbutton lock, a keyed bar lock, and the like.

Material separator 214 comprises rigging members 292 and 293 as well and as previously described. However, material separator 214 includes a pick up assembly that comprises a pair of removable pick up members 295 and 297. Pick up member 301 comprises bar 300 coupled at one end thereof by weld 302 for example. Pick up member 297 comprises hole 298 there through. Bar 300 can be removably coupled/slid through holes 273 and 275 and hole 298 so that pick up member 297 can be removably coupled to the free end of bar 300 so that a front end bucket of a backhoe may engage pick up members 301 and 297 and lift and move reducer grate deck 260.

Further implementations are within the CLAIMS.
C. Specifications, Materials, Manufacture, and Assembly

It will be understood that material separator implementations are not limited to the specific components disclosed herein, as virtually any components consistent with the intended operation of a material separator implementation may be utilized. Accordingly, for example, although particular components material separator implementations are disclosed, such components may comprise any shape, size, style, type, model, version, measurement, concentration, material, quantity, and/or the like consistent with the intended operation of a material separator implementation. Implementations are not limited to uses of any specific components, provided that the components selected are consistent with the intended operation of a material separator implementation.

Accordingly, for the exemplary purposes of this disclosure, the components defining any material separator implementation may be formed of any of many different types of materials or combinations thereof that can readily be formed into shaped objects provided that the components selected are consistent with the intended operation of a material separator implementation. For example, the components may be formed of: polymers; composites; metals, such as titanium, iron, steel, carbon steel, alloy steel, tool steel, stainless steel, aluminum, any combination thereof, and/or other like materials; alloys; any other suitable material; and/or any combination thereof.

Additionally, for the exemplary purposes of this disclosure, components may be formed of metal tube or bar stock, plate stock, angle stock, channel stock, and the like. For example, the grate members may be square tubes (e.g., 2″×2″×¼″) or bars (e.g., 2″×2″), rectangular tubes or bars, or the like that are turned on their edges so that they have a substantially diamond shape in cross-section. Spacing between main deck grate members of one material separator implementation may be about 4″, while in other implementations spacing of virtually any dimension may be provided, such as about 1″ to about 12″for example. In another material separator implementation, the spaces between upper ends of grate members may be less than the spaces between lower ends of the grate members. Spacing between reducer deck grate members and main deck grate members may be of virtually any dimension (e.g. about ¼″ to about 11″) subject to the spacing of main deck grate members.

Furthermore, the components defining any material separator implementation may be purchased pre-manufactured or manufactured separately and then assembled together. However, any or all of the components may be manufactured simultaneously and integrally joined with one another. The various implementations may be manufactured using conventional procedures as added to and improved upon through the procedures described here.

Accordingly, manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. Components that are manufactured separately may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.
D. Use

Material separator implementations are particularly useful for the separation and recycling of excavated material. However, implementations are not limited to uses relating to the foregoing. Rather, any description relating to the foregoing is for the exemplary purposes of this disclosure, and implementations may also be used with similar results for a variety of other applications and to sort all forms of aggregate materials, including stone, rubble, soil, gravel, sand, and recyclable materials, including concrete, brick, cinderblock, asphalt, and other demolition debris.

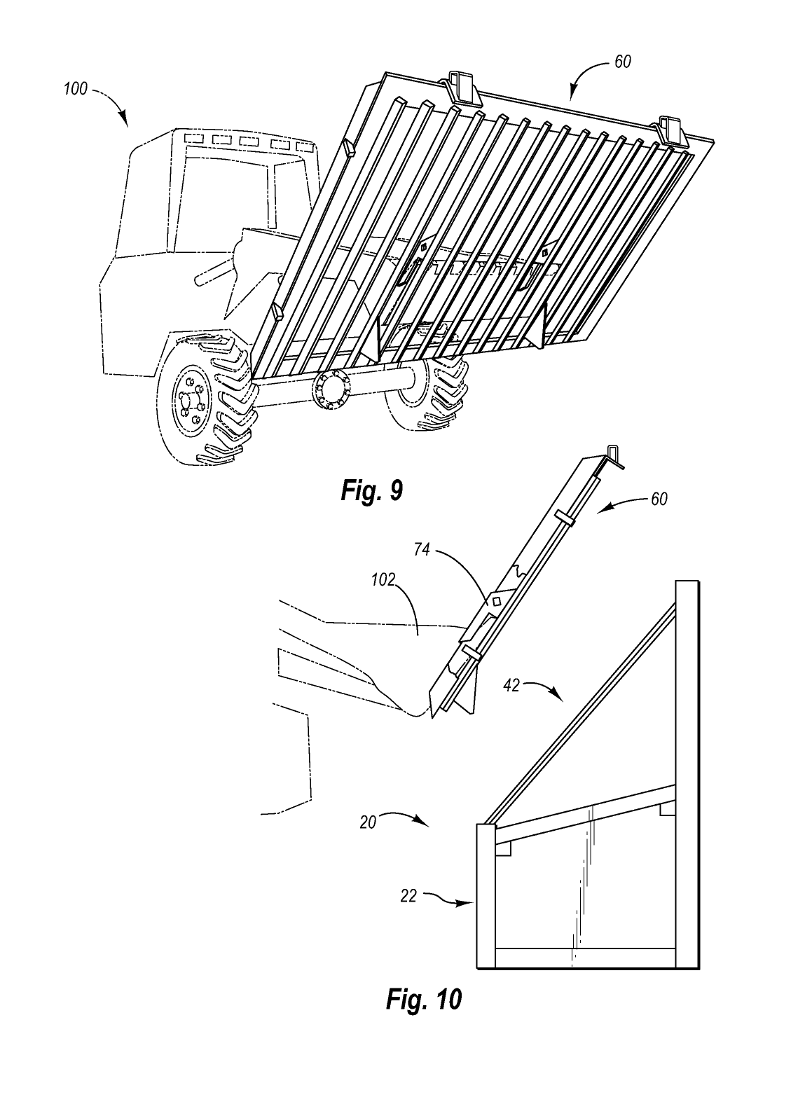

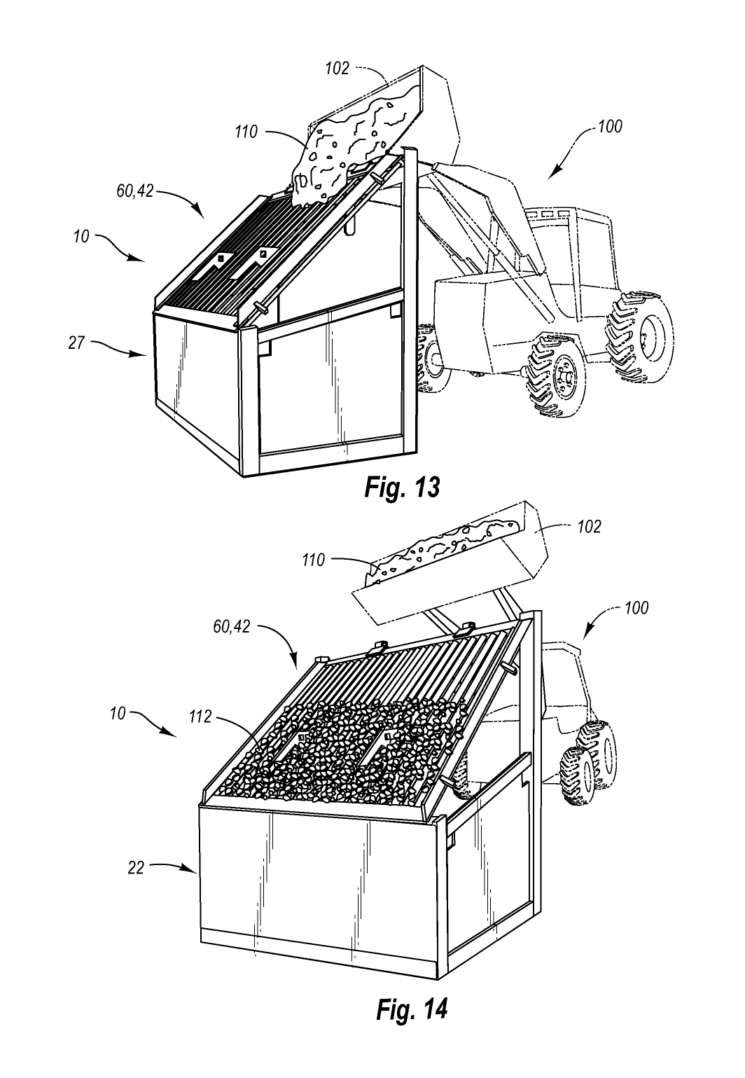

In describing the use of material separator implementations further and for the exemplary purposes of this disclosure, FIGS. 9-16 depict material separator 10 in conjunction with equipment 100 (e.g., a backhoe with a front end bucket).

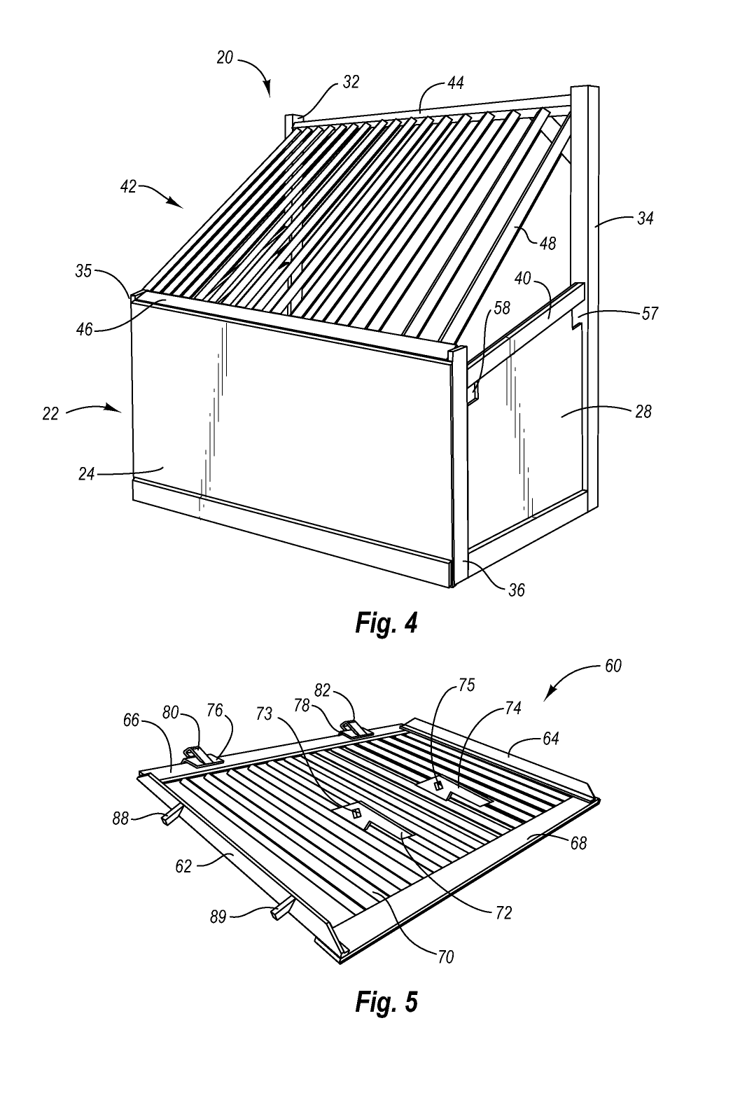

Referring to FIG. 4, during use, material to be separated may first be deposited on slanted grate deck 42 from the back of frame 20 (not shown). Smaller course material falls through slanted grate deck 42 into base 22 while larger course material falls off of slanted grate deck 42 and in front of front wall 24 of base 22. The recycled smaller course material may then be moved from open back 30 of base 22.

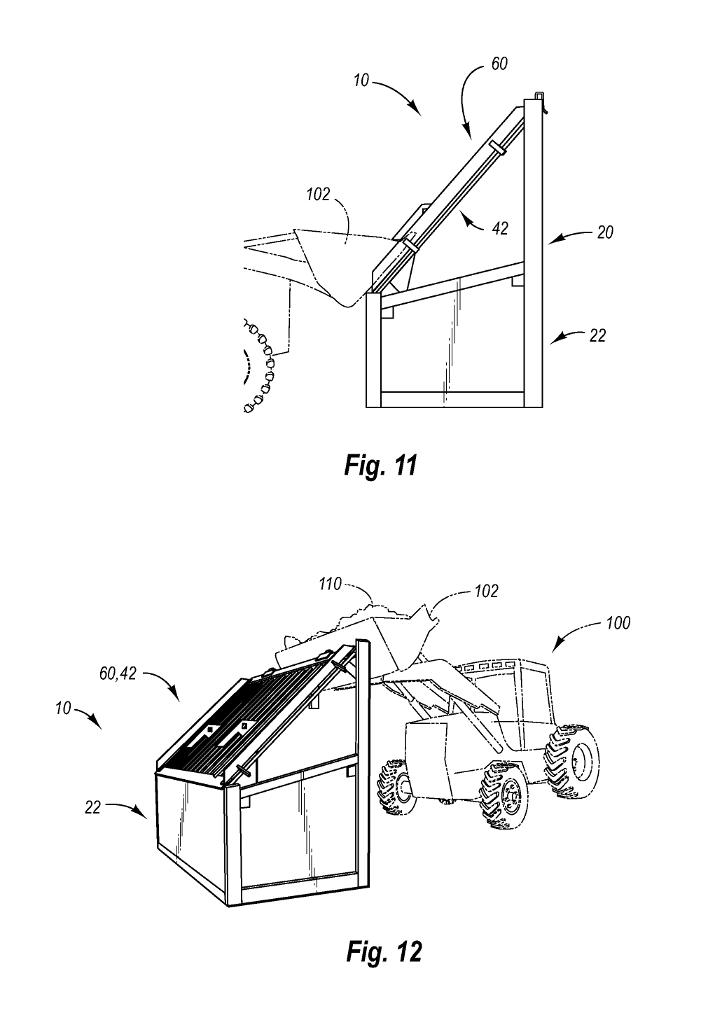

As specifically illustrated in FIGS. 9-10, portable reducer grate deck 60 having two external pick up members 72 and 74 may be lifted and transported by engaging the front end of bucket 102 of equipment 100 with pick up members 72 and 74. Turning to FIGS. 10-11, then reducer grate deck 60 is easily, properly, and automatically positioned on slanted grate deck 42 of frame 20 by seating tabs 88-91. Once reducer grate deck 60 is in position, it is held in place with respect to slanted grate deck 42 via catch members 76 and 78 pivotally engaging upper end member 44 of slanted grate deck 42. As shown in FIG. 7, grate members 70 mesh or nest between grate members 48 to form a unitary, flush decking.

Next, referring to FIGS. 12-14, the previous recycled smaller course material may be deposited on the unitary, flush decking formed by reducer grate deck 60 and slanted grate deck 42 thereby allowing even finer material to pass through to further separate and recycle the material. Material too coarse to pass through falls off of the decking in front of front wall 24 of base 22. The recycled smaller course material may then be moved from open back 30 of frame 22. Similarly, this finer material may continue to be further separated by changing out the reducer grate deck and replacing it with another reducer grate deck that will screen out even smaller material.

Turning to FIG. 15, if the decking formed by reducer grate deck 60 and slanted grate deck 42 becomes clogged with material 112 (clogging material 112 gets trapped between grate members 48 and 70 during separation of the material), bucket 102 is aligned with bumpers 84 and 86 and then equipment 100 is driven forward allowing bucket 102 to slidably engage internal bumpers 84 and 86 of reducer grate deck 60 and slidably push the free, non-pivoting end of reducer grate deck 60 upwards to clear or release clogged material 112. Equipment 100 is continued to be driven forward to allow bumpers 84 and 86 to slip inside of bucket 102 and reducer grate deck 60 to fall forcefully back into position, further shaking loose or crushing any lingering clogging materials 112. Additionally, during this entire process, bucket 102 is in a position to catch any released clogging material 112 that may fall through the decking so it can be reprocessed if desired or discarded, thereby preventing released clogging material 112 from mixing with/contaminating the previously separated finer material. Reducer grate deck 60 is easily, properly, and automatically re-positioned/re-seated back on slanted grate deck 42 by seating tabs 88-91, which keep reducer grate deck 60 centered with slanted grate deck 42 so as to not change the spacing between grate members 48 and 70 and ultimately the size of screened material.

Referring to FIG. 16, in order to transport and move frame 20, or for that matter the entire material separator 10, bucket 102 may engage lift members 50 and 52 by contacting the bottom side of slanted grate deck 42 such that lift members 50 and 52 reside outside bucket 102 and adjacent to a back edge of bucket 102. This engagement temporarily secures frame 20 to bucket 102 when frame 20 is lifted from ground 120 and moved.

In describing the use of material separator implementations further and for the exemplary purposes of this disclosure, FIGS. 24-26 depict material separator 210 in conjunction with equipment 100 (e.g., a backhoe with a front end bucket 102). The use of material separator 210 is similar to the use of material separator 10 previously described.

Referring to FIG. 24, in order to transport and move frame 220, or for that matter the entire material separator 210, bucket 102 may engage suspended deck support 250 by contacting the bottom side of slanted grate deck 242 such that suspended deck support 250 resides outside bucket 102 and adjacent to a back edge of bucket 102. This engagement temporarily secures frame 220 to bucket 102 when frame 220 is lifted from ground 120 and moved.

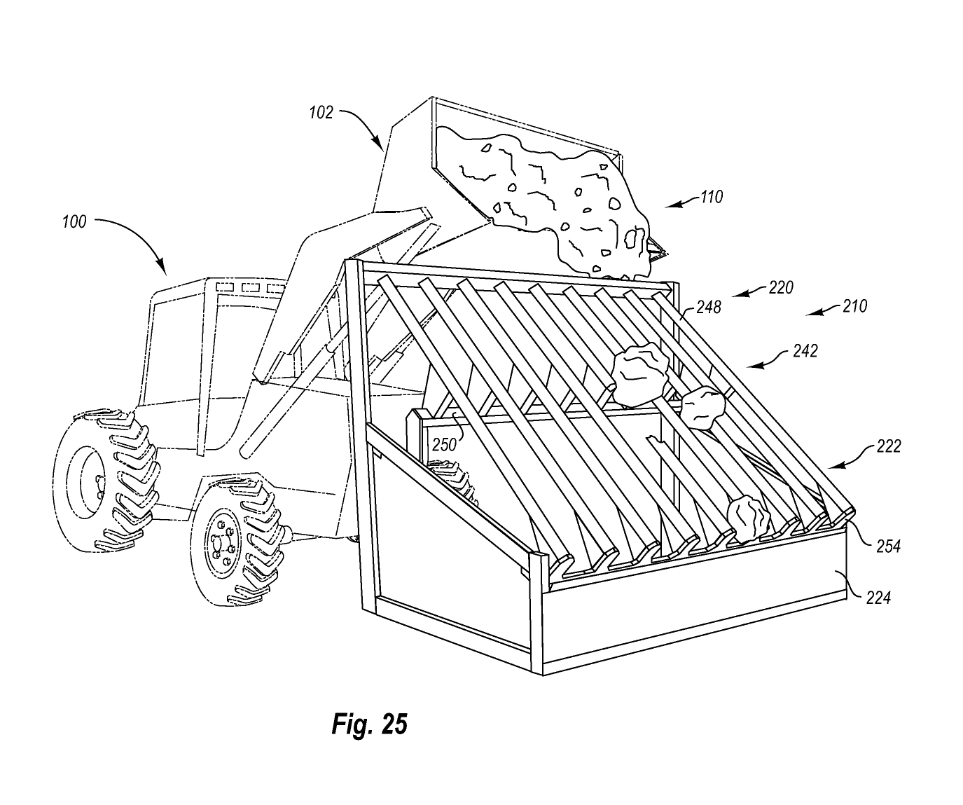

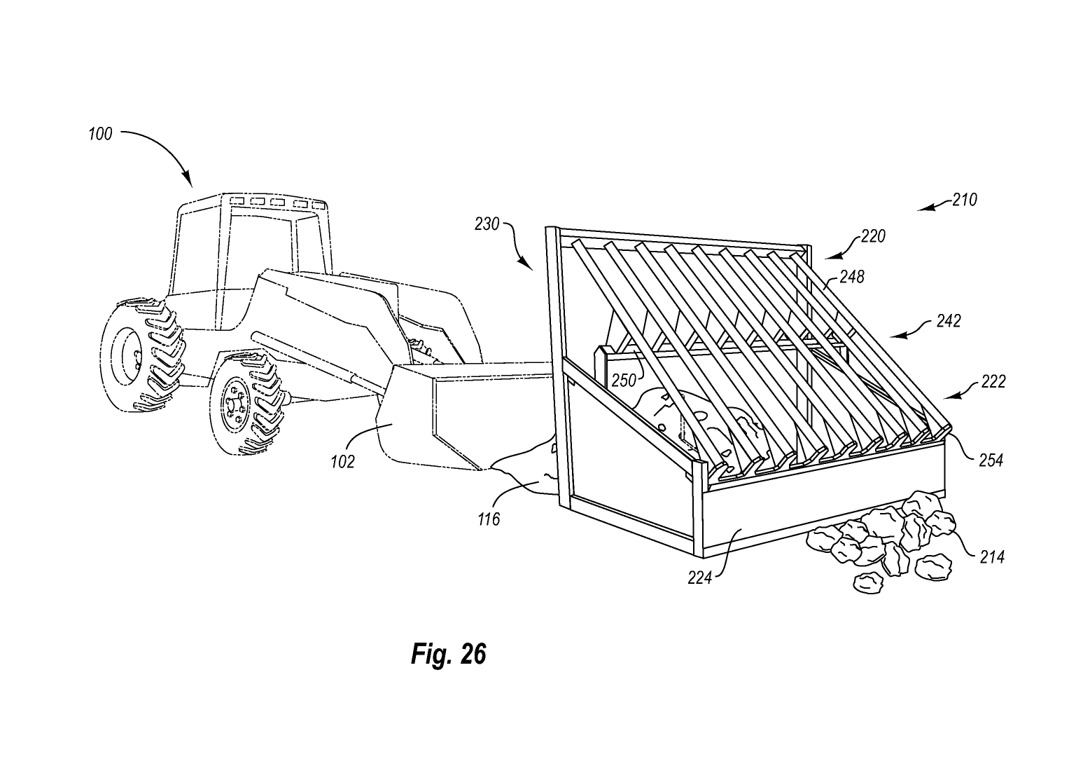

Turning to FIGS. 25-26, generally, during use, material 110 to be separated may first be deposited on slanted grate deck 242 from the back of frame 220. Smaller course material 116 falls through slanted grate deck 242 into base 222 while larger course material 214 falls off of slanted grate deck 242 and in front of front wall 224 of base 222. The smaller course material 116 may then be moved from open back 230 of base 222.

Specifically, slanted grate deck 242 does not become clogged with material 214; material 214 does not get trapped between grate members 248 during separation. Rather, finer material 116 is separated and accumulates in base 222. Larger course material 214 falls off of slanted grate deck 242 and in front of front wall 224 of base 222. This is accomplished in part because of the multiple funnels/channels between grate members 248 as described previously. However, this is also accomplished because of the predetermined distance suspended deck support 250 is separated from slanted grate deck 242 and the spaces between upper ends of grate members 248 being less than the spaces between lower ends grate members 248 as described previously. In addition, this is also accomplished because slanted grate deck 242 is separated a predetermined distance from the top of front wall 224 providing an “open front” as described previously. Each of these features alone, or their combination together, allow larger and irregularly shaped material to shed more freely and not clog up against deck support 250, at the end of slanted grate deck 242, or for that matter at any point along the length of grate bars 248.

1. A material separator comprising:
a frame comprising a base supporting a slanted grate deck, the base comprising:
a front wall and two opposing side walls; and
a suspended deck support positioned below and separated a predetermined distance from the slanted grate deck by at least one deck brace.

2. The material separator of claim 1, wherein the slanted grate deck further comprises a plurality of grate members and wherein the predetermined distance between the slanted grate deck and the deck support is one of equal to or greater than a distance between grate members.

3. The material separator of claim 1, wherein the slanted grate deck further comprises a plurality of grate members and wherein the at least one deck brace comprises a plurality of corresponding deck braces, each deck brace coupled between a bottom portion of a corresponding grate member and the suspended deck support.

4. The material separator of claim 3, wherein the predetermined distance between the slanted grate deck and the deck support is one of equal to or greater than a distance between grate members.

5. The material separator of claim 1, wherein the suspended deck support extends across an entire width of the slanted grate deck.

6. The material separator of claim 5, wherein the suspended deck support is positioned above and separated a predetermined distance from tops of the opposing side walls of the base by opposing side wall braces coupled between end portions of the suspended deck support and top portions of the opposing side walls.

7. The material separator of claim 5, wherein the slanted grate deck further comprises a plurality of grate members and wherein the at least one deck brace comprises a plurality of corresponding deck braces, each deck brace coupled between a bottom portion of a corresponding grate member and the suspended deck support.

8. The material separator of claim 7, wherein the predetermined distance between the slanted grate deck and the deck support is one of equal to or greater than a distance between grate members.

9. The material separator of claim 7, wherein the grate members and the deck support are substantially diamond shape in cross-section.

10. The material separator of claim 7, wherein the grate members are of a different size than the deck support.

11. The material separator of claim 1, wherein the slanted grate deck further comprises a plurality of grate members and wherein the space between upper ends of at least two grate members is less than the space between lower ends of the at least two grate members.

12. The material separator of claim 11, wherein the spaces between the upper ends of all of the plurality of grate members are less than the spaces between the lower ends of all of the plurality of grate members.

13. The material separator of claim 12, wherein the spaces between the upper ends of all of the plurality of grate members are equidistant and less than the spaces between the lower ends of all of the plurality of grate members.

14. The material separator of claim 1, wherein the slanted grate deck comprises an upper end member, an opposing lower end member, and a plurality of grate members located and coupled between the opposing end members, wherein the opposing lower end member is a top of the front wall.

15. The material separator of claim 14, wherein the opposing lower end member comprises one of:
a plurality of teeth coupled to lower ends of the grate members; and
a plurality of reentrant openings defined between coupling locations of lower ends of the grate members.

16. The material separator of claim 1, wherein the slanted grate deck comprises an upper end member, an opposing lower end member, and a plurality of grate members located and coupled between the opposing end members, and wherein the opposing lower end member forms a portion of a top of the front wall positioning the slanted grate deck above and separating it a predetermined distance from the top of the front wall.
